(19) United States
(12) Patent Application Publication
(10) Pub. No.: US 2008/0050507 A1
(43) Pub. Date: Feb. 28, 2008

(54) HIGH PRESSURE PROCESSING OF FOODS

(76) Inventor: William Jaehnert, Oconomowoc, WI (US)

Correspondence Address: BELL, BOYD & LLOYD, LLP, P.O. Box 1135, CHICAGO, IL, 60690, US

(21) Appl. No.: 11/467,419

(22) Filed: Aug. 25, 2006

(51) Int. Cl. A23L 1/31

(52) U.S. Cl. 426/641

(57) ABSTRACT

High pressure processing (HPP) uses isostatic pressure to evenly apply great pressures to foods on all sides of the foods. Because the pressure is isostatic, the food is not deformed, so long as there is no internal cavity in the food. The pressures used are preferably from about 100 MPa (about 14.5 ksi) to about 1000 MPa (about 145 ksi), and the temperature rise is preferably limited to about 3° C. (about 5° F.) per 100 MPa (about 14.5 ksi). The high pressure dramatically reduces pathogens in the food so processed, as much as a four or five-log reduction in counts of colony forming units (CFU). The process has been shown to be effective in achieving these reductions in E. Coli, listeria, and salmonella. Pieces or sticks of beef jerky or sausage may be processed via HPP and combined with cheese to form a food product with a long shelf life.

### FIELD OF THE INVENTION

The field of the invention is food processing, with improved food combination and methods for processing the foods.

### BACKGROUND OF THE INVENTION

Subjecting foods to high pressure processing (HPP) has been recognized as a way to reduce harmful bacteria and preserve the foods. For example, U.S. Pat. No. 5,213,029 discloses a method for subjecting foods to a high pressure (not specified) and also discloses a complicated way to keep the foods cool using a cooling device within the high pressure isostatic pressure vessel. This is a very complicated technique, but no particular temperatures or pressures are specified.

U.S. Pat. No. 5,316,745 discloses a method for high pressure processing of foods. Pressures from about 40,000 psi to 55,00 psi and higher are recommended (about 275 to about 380 MPa). The patent discloses that water will compress to as little as 85% of its initial volume at room pressure. No temperature for the process is specified.

U.S. Pat. No. 5,683,735 discloses a method for flavoring a drink by subjecting a flavoring to high pressure from 100-400 MPa (about 14.5 to about 58 ksi) for a period of time from about 10 seconds to 60 minutes. The flavor is then added to the drink. the amount of flavoring as little as one part of flavor to 10 to 1000 parts of juice. No mechanism for explaining the favorable results was postulated, and no processed quantities were indicated, although the temperature was specified as “room temperature.”

Another technique for preserving food is disclosed in U.S. Pat. No. 6,017,572. This patent teaches preheating the food to at least 70° C. and then subjecting the food to two quick pressure cycles of at least 50,000 psi (345 MPa). The pressure may be as high as 140,00 psi (880 MPa) and the intervals may be from 0 to 5 minutes. This technique has the obvious disadvantage of requiring heating of the food, which adds time and expense to the process. U.S. Pat. No. 6,177,115, continuation-in-part, teaches these and an even higher temperature, 106° C. and a lower pressure, 30,000 psi (207 MPa).

U.S. Pat. No. 6,033,717 discloses another technique for preserving foods using pressure. The technique involves passing the food through a narrow tube in which the discharge end of the tube is maintained at a pressure of at least 100 MPa (14.5 ksi) while limiting the pressure rise within the tube to about 5° C. (about 9° F.). Residence time in the tube should be at least one second.

With the exception of the disclosure of improving the flavor of the drink by processing the flavor to be added (U.S. Pat. No. 5,683,735), these disclosures do not teach an extension of high pressure processing to achieve a benefit other than reducing harmful bacteria or preservation. What is needed is a better way to use high pressure processing to achieve benefits beyond pressure sterilization and processing. These and other advantages of the invention, as well as additional inventive features, will be apparent from the description of the invention provided herein.

### BRIEF SUMMARY OF THE INVENTION

One aspect of the invention is a method for preparing a food product. The method includes steps of providing pieces of a meat product; treating the pieces by subjecting the pieces to a pressure of at least about 50 MPa (about 7 ksi), preferably at least about 586 MPa (about 85 ksi), and combining the treated pieces with a second food to form a food product.

Another aspect of the invention is a combination food. The combination food includes a cheese and particles from a process for producing jerky, wherein the particles are intimately and thoroughly mixed throughout the cheese, and wherein the particles or the combination food have been subjected to a pressure of at least about 50 MPa (about 7 ksi) at a temperature less than about 50° C. (about 122° F.), preferably at least about 586 MPa (about 85 ksi).

Another aspect of the invention is a combination food. The combination food includes a cheese and pieces from a process for producing a meat product, wherein the pieces are thoroughly mixed with the cheese.

Other embodiments and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. The drawings are meant to be illustrative rather than limiting. In the drawings:

FIG. 1 depicts a first embodiment of a process for preparing food products using high pressure processing; and

FIG. 2 depicts a second embodiment of a process for preparing food products using high pressure processing.

While the invention will be described in connection with certain preferred embodiments, there is no intent to limit it to those embodiments. The intent is to cover all alternatives, modifications and equivalents as included within the spirit and scope of the invention as defined by the appended claims.

### DETAILED DESCRIPTION OF THE PRESENTLY PREFERRED EMBODIMENTS

As recognized in many of the prior art documents discussed above, the use of high pressure processing (HPP), with or without heat, achieves great benefits in stabilization of foods by apparently killing bacteria and other microorganisms in the food. Without being bound by any particular theory, it is believed that the high pressure renders the bacteria or other microorganisms inactive by damaging their cellular structure. It is believed that the high pressure disrupts the protein structure of the membrane of the cell, and that the microorganism then ceases to function as a living organism. This treatment is effective against pathogens such as listeria or Escheria coli O157:H7 (E. Coli), when using the high pressures typically used for processing foods, about 7-145 ksi (about 50-1000 MPa).

If this stabilization and reduction in harmful bacteria can be accomplished without adding heat, there will also be an additional benefit of preserving the natural flavor and texture, and nutritional attributes of the food. Accordingly, the embodiments described below preferably do not allow more than a nominal temperature rise during the high pressure processing. For instance, in raising pressure about 100 MPa (about 7 ksi), temperature rises have been about 3° C. (about 5° F.) per 100 MPa. This is the adiabatic temperature rise caused by the isostatic high pressure processing equipment. Such equipment is available from Avure Technologies, Kent, Wash., and from others.

As is well known, the application of high pressure on all sides of an object (isostatic pressurization) may leave unchanged the appearance of the object, such as a food item. Of course, this does not apply to foods or objects that have internal cavities, such as whole strawberries, or other exceptions. The benefits of HPP may be extended to other uses in food processing. For example, since HPP is known to reduce pathogens in foods, those foods that are especially vulnerable to such pathogens may be subjected to HPP. These foods may also serve as ingredients in combination food products, such as snacks.

For example, beef jerky is a popular snack. Production of beef jerky is a labor intensive process in which fat is removed from the meat, and the meat is then sliced into strips. The strips or pieces are then cured and smoked, i.e., dried, typically with the addition of salt. In some processes, the meat is comminuted, i.e., diced or ground into pieces. The pieces are then molded into strips. Then the molded strips are cured and smoked, just like meat from the slicing process. After the meat is dried, flavor may be added, such as hickory smoke, pepperoni, honey mustard, mesquite, teriyaki, jalapeno pepper, or any of many flavors or spices.

While beef jerky may be the most popular kind of jerky snack, many meats may be processed into jerky. A non-exclusive list includes alligator, buffalo, chicken, lamb, pork, salmon, shark, tuna, turkey, veal, venison, and meat from other animals. In addition, jerky may be made in forms other than the traditional longitudinal strips. Jerky may come in nuggets, chunks, or slabs. Sales of the very popular jerky and similar snacks in the United States are currently approaching $3 billion per year.

It is clear that jerky is a highly processed snack food. One problem that arises during processing is an unwanted by-product, the fine particles of jerky that inevitably result from the processing. These particles, jerky fines, are not easily molded into shapes. Because of their very small particle size, they have a very high surface area and are just as susceptible, if not more so, to invasions of microorganisms or pathogens. If a use were found for these jerky fines, the high-pressure process described above would easily be able to eliminate pathogens, assuring a long shelf life for snacks made with jerky fines.

High pressure processing is effective to reduce microorganisms such as bacteria in food. This is especially helpful in reducing harmful pathogens in meat products, such as jerky, sausage, and other meats. The meat may be in the form of strips, shreds, chunks, or particles, including fine particles or fines. Strips may be several inches long and of varying cross section, shreds may be of varying sizes, chunks may also be of almost any size, such as ½″ chunks to ¼″ chunks or less. Other sizes of strips, shreds, chunks or particles may be used. The meat in the food product may amount to any desired portion of the final product, e.g., 50%, 25%, 5%, 3%, 2%, or other percentage. Other percentages may be used.

The fine particles or fines produced as a by-product of beef jerky vary significantly in their sizes. These fines may also be used in combination food embodiments. The fines are much too small to handle individually. In one example, fine particles from three samples of beef jerky processing were sieved and tested as follows for particle size:

TABLE 1
(average of three samples)

| Retained on screen | Micron size | Weight Percent |
|---|---|---|
| 6 | 3360 | 47.82 |
| 8 | 2380 | 24.93 |
| 12 | 1680 | 12.84 |
| 18 | 1191 | 7.78 |
| Pan | 37 | 6.61 |

Meat products, including jerky, chicken, turkey, or sausage in many forms, may be processed in bulk to reduce pathogens as described above. The meat products may then be combined in desired proportions to form a food product. For example, sausage chunks may be combined with Swiss cheese to yield cheese-sausage sticks. Beef jerky particles may be combined with American cheese to form cheese jerky sticks. Beef jerky fines may be combined with cheddar cheese to yield a beef and cheddar jerky. In addition, a flavor may be added to any of these, such as hickory smoke, pepperoni, honey mustard, mesquite, teriyaki, jalapeno pepper, or other flavor or spice.

In order to expedite processing, the content of the jerky fines may be kept below the minimum required for inspection by the United States Department of Agriculture (USDA), three percent for uncooked meat or poultry, two percent for cooked meat or poultry. If a product with additional meat or poultry content is desired, the product may be formulated and inspected before it is shipped from the plant manufacturing the product. HPP will add significantly to the shelf life of the products made by this process. Of course, if foods or susceptible ingredients are processed at pressures lower than those recommended herein, a benefit will be achieved by reducing the quantity and concentrations of harmful pathogens. Nevertheless, high pressure processing at the higher pressure noted herein is preferred because of the greater benefits for the consuming public.

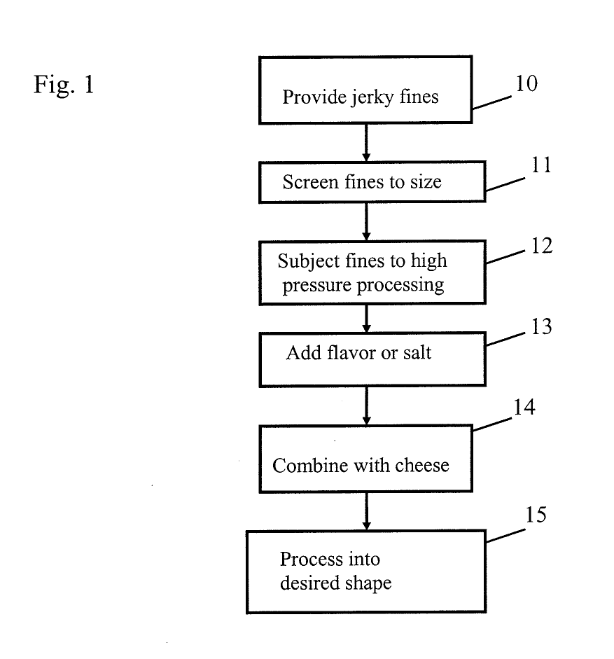

A process for preparing a food combination using fine particles and another food is depicted in the flowchart of FIG. 1. Fine particles, or fines, from the processing of beef jerky, or other jerky, are provided 10. The processes used by meat packers vary, even day to day within the same plant, and the size distribution of the particles may also vary. Optionally, the fines may be sieved or screened 11 and only a selected size range used, e.g., only fines able to pass through a 60 mesh screen. The particles are then subjected to high pressure processing (HPP) 12, preferably for a period of 1 to 3 minutes, or longer, and preferably at a pressure sufficient to kill a desired amount of the pathogens present in the particles. In one example, the fines are subjected to at least 85 ksi for a three minute period. The temperature rise, as outlined above, should be minimal.

The fines may be combined with another food, such as cheese, to form a combination food, such as a cheese jerky spread or cheese jerky sticks. The process may include a step of adding a flavor, spice or salt to the fines or to the combination 13. If a flavor, salt or spice has not been previously added, it may be added after the fines are combined with the cheese 14. Finally, the mixture may be processed into desired shapes 15. A cheese spread, with relatively softer cheese, may be pumped into small tubs, the tubs having roughly the shape of a truncated cone or cylinder. Alternatively, a mixture with a firmer cheese may be shaped into slim cylinders, to make a cheese jerky snack.

In preparing products using the jerky fines and a cheese, a soft cheese is preferred, if only so the fines and any other desired ingredients may be more easily added. This will result in better mixing and contact between the fines and the cheese, minimizing agglomeration and stratification of the fines. Any cheese may be used. Examples of cheese that may be preferred include brick cheese, Swiss cheese, Edam cheese, Gouda cheese, Muenster cheese, Mozzarella cheese, Provolone cheese, American cheese, Cheddar cheese, Colby cheese, Colby-Jack cheese, and Monterey Jack cheese.

Processed jerky normally has very little water content, a result of the slicing, curing, salting, and smoking processes used to produce jerky. It is recognized that cheeses necessarily contain a large amount of water. In referring to cheese, the water content is included. Thus, if a cheddar cheese cylinder or stick with about 2.9% jerky is formed, the remainder, 97.1%, will include cheese, and any added flavor, spice, or salt. If flavor, spice, and salt constitute about 3% of the product, the remaining 94.1% is cheese and water, with about 48% cheese solids and the remainder, about 46%, water.

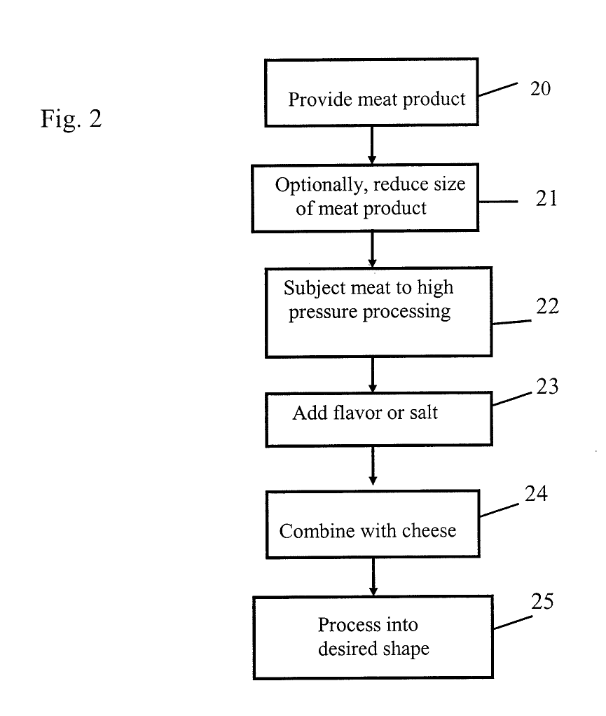

A process for preparing a food combination using meat and another food is depicted in the flowchart of FIG. 2. Meat or meat particles, such as chunks or shreds, are provided 20. Optionally, the meat may be processed 21 into smaller pieces, such as by cutting or slicing. The pieces, shreds, or sticks are then subjected to high pressure processing (HPP) 22, preferably for a period of 1 to 3 minutes, or longer, and preferably at a pressure sufficient to kill a desired amount of the pathogens present in the particles. In one example, the fines are subjected to at least 87 ksi (600 MPa) for a three minute period. The temperature rise, as outlined above, should be minimal.

The pieces, shreds, or sticks may be combined with another food, such as cheese, to form a combination food, such as a cheese jerky spread or cheese jerky sticks. The process may include a step of adding a flavor, spice or salt to the meat or to the combination 23. If a flavor, salt or spice has not been previously added, it may be added after the meat or meat pieces are combined with the cheese 24. Finally, the mixture may be processed into desired shapes 25. A cheese spread, with relatively softer cheese, may be pumped into small tubs, the tubs having roughly the shape of a truncated cone or cylinder. Alternatively, a mixture with a firmer cheese may be shaped into slim cylinders, such as with sticks of beef jerky or sausage, to make a cheese jerky snack.

High pressure processing tests were conducted on several batches of foods to insure that the pressures were sufficient to have a cidal effect on the appropriate bacteria. In one test, cheddar cheese was subjected to a pressure of 87 ksi (about 600 MPa) for about three minutes. Tests were conducted for E. Coli O157:H7 before and after and a reduction from 43 MPN/g to less than 3 MPN/g was achieved.

In a second series of tests, uncured turkey breast meat was inoculated with a high level of listeria monocytogenes and then subjected to a pressure of 85 ksi (586 MPa) for about three minutes. Tests were conducted for listeria before and after, and a reduction from about 4.00 log CFU/g to less than the detectable limit of 0.70 log CFU/g was achieved.

Additional tests were also conducted with lower levels of listeria inoculations in uncured turkey breast meat. Separate samples were subjected to a pressure of 85 ksi (586 MPa) for time periods of three minutes, four minutes, and five minutes. In these tests, high pressure processing allowed a reduction from about 2.11 log CFU/g to less than the detectable limit of 0.70 log CFU/g, as measured after 4 days of storage at about 4° C. The samples were then periodically tested for a period extending to 100 days after high pressure processing, the samples stored at 4° C. in the interim. These samples gave indications of a slightly higher level 32 days after high pressure processing, while all tests at the 46, 70 and 100 day marks were below the detectable limit.

This testing demonstrates that HPP is very effective in eliminating pathogens in only three to five minutes of high pressure processing, and that the effects are very long-lasting. While not being bound by any particular theory, this may be why it is only necessary to treat the meat portion of the cheese and jerky snack embodiments of the present invention. The volume of the jerky or other meat that is used, preferably about 2% to about 25% or more of the food product, can be subjected to high pressure processing without subjecting the remainder of the food, preferably cheese, to high pressure processing. Thus, by treating only the smaller volume of food product, a significant reduction in pathogens is achieved, making the combination food product safer.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments are described herein, including the best mode known to the inventors for carrying out the invention. Variations of those preferred embodiments may become apparent to those of ordinary skill in the art upon reading the foregoing description. Skilled artisans will use such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for preparing a food product, the method comprising:
providing pieces of a meat product;
treating the pieces by subjecting the pieces to a pressure of at least about 50 MPa (about 7 ksi), preferably at least about 586 MPa (about 85 ksi); and
combining the treated pieces with a second food to form a food product.

2. The method of claim 1, wherein the second food is cheese.

3. The method of claim 1, wherein the pieces comprise a byproduct from production of meat jerky.

4. The method of claim 1, wherein a temperature rise resulting from the method is less than about 3° C. (about 5° F.) per 100 MPa (about 14.5 ksi).

5. The method of claim 1, wherein the pieces are subjected to the pressure using an isostatic pressure machine.

6. The method of claim 1, wherein the pressure is held for a minimum of three minutes during the step of pressurizing.

7. The method of claim 1, further comprising adding a flavor or a spice before or after the step of combining.

8. The method of claim 1, further comprising forming the food product into a generally cylindrical shape or truncated conical shape after the step of combining.

9. The method of claim 1, wherein the pieces are the products of processed meat selected from the group consisting of beef jerky, chicken jerky, fish jerky, lamb jerky, goat jerky, mutton jerky, pork jerky, sausage, elk jerky, and deer jerky.

10. A combination food, comprising:
a cheese; and
particles from a process for producing jerky, wherein the particles are intimately and thoroughly mixed throughout the cheese, and wherein the particles or the combination food has been subjected to a pressure of at least about 50 MPa (about 7 ksi) at a temperature less than about 50° C. (about 122° F.), preferably at least about 586 MPa (about 85 ksi).

11. The combination of claim 10, wherein the particles are a by-product of processing meat selected from the group consisting of beef jerky, chicken jerky, fish jerky, lamb jerky, goat jerky, mutton jerky, pork jerky, elk jerky, and deer jerky.

12. The combination of claim 10, further comprising a flavor, a salt, or a spice.

13. The combination of claim 10, wherein the particles or the combination food has been subjected to the pressure for at least two minutes.

14. The combination of claim 10, wherein the particles comprise less than three percent of the combination food.

15. The combination of claim 10, wherein the cheese is selected from the group consisting of brick cheese, Swiss cheese, Edam cheese, Gouda cheese, Muenster cheese, Mozzarella cheese, Parmesan cheese, Provolone cheese, Romano cheese, American cheese, Cheddar cheese, Colby cheese, Colby-Jack cheese, and Monterey Jack cheese.

16. A combination food, comprising:
a cheese; and
pieces from a process for producing a meat product, wherein the pieces are thoroughly mixed with the cheese.

17. The combination of claim 16, wherein the pieces comprise less than three percent of the combination food.

18. The combination of claim 16, wherein the pieces or the combination food have been subjected to a pressure of at least about 100 MPa (about 14.5 ksi) at a temperature less than about 50° C. (about 122° F.), and preferably at least about 586 MPa (about 85 ksi) at a temperature less than about 40° C. (about 104° F.).

19. The combination of claim 16, wherein the pieces are a by-product from the process for producing a meat product.

20. The combination of claim 16, wherein the further comprising a flavor, a salt, or a spice.
